(19) United States
(12) Patent Application Publication
(10) Pub. No.: US 2025/0252451 A1
(43) Pub. Date: Aug. 7, 2025

(54) METHOD OF MEASURING CARBON EMISSIONS AND SERVICE SERVER THEREOF

(71) Applicant: Electronics and Telecommunications Research Institute, Daejeon (KR)

(72) Inventor: Jee Sook EUN, Daejeon (KR)

(73) Assignee: Electronics and Telecommunications Research Institute, Daejeon (KR)

(21) Appl. No.: 19/042,490

(22) Filed: Jan. 31, 2025

(30) Foreign Application Priority Data
Feb. 1, 2024 (KR) 10-2024-0016055

(51) Int. Cl. G06Q 30/018; G01D 21/02; G05D 27/02; G06Q 50/02

(52) U.S. Cl. CPC G06Q 30/018; G06Q 50/02; G01D 21/02; G05D 27/02

(57) ABSTRACT

The present invention relates to a method of measuring carbon emissions, which includes collecting, by a processor, livestock house environment data from one or more twin livestock houses, and selecting, by the processor, one or more factors from the livestock house environment data and generating a plurality of carbon emission measurement models.

### CROSS-REFERENCE TO RELATED APPLICATION

This application claims priority to and the benefit of Korean Patent Application No. 10-2024-0016055, filed on Feb. 1, 2024, the disclosure of which is incorporated herein by reference in its entirety.

### BACKGROUND

### 1. Field of the Invention

The present invention relates to a method of measuring carbon emissions based on a digital twin and a service server thereof.

### 2. Discussion of Related Art

As global interest in carbon emissions grows in response to the climate crisis, a method of measuring carbon emissions from livestock is needed in livestock houses as well. Conventionally, a default emission coefficient value (1.5 kg of methane/head/year) set by the Intergovernmental Panel on Climate Change (IPCC) has been used as it is to calculate carbon emissions. However, because each country has different livestock breeding environments and feeding techniques, country-specific emission coefficients are needed to accurately calculate greenhouse gas emissions. Therefore, each country is making efforts to measure its own unique emission coefficients, and in Korea, the National Institute of Animal Science, Rural Development Administration, has developed and distributed eight types of national emission coefficients for pigs. However, these emission coefficients are measured for intestinal fermentation at each stage of pig breeding and are somewhat different from greenhouse gas emissions from livestock houses during breeding.

### SUMMARY OF THE INVENTION

The present invention is directed to providing a method of measuring carbon emissions capable of measuring carbon emissions from livestock houses by generating a general-purpose carbon emission measurement model using a data model that accurately calculates carbon emissions from livestock houses, and a service server thereof.

According to an aspect of the present invention, there is provided a method of measuring carbon emissions, which includes collecting, by a processor, livestock house environment data from one or more twin livestock houses, and selecting, by the processor, one or more factors from the livestock house environment data and generating a plurality of carbon emission measurement models.

The livestock house environment data may include external environment information including at least one of factors such as an external temperature, an external humidity, a wind speed, an atmospheric pressure, or a latitude, or combination thereof, and internal environment information including at least one of factors such as a manure temperature, a manure pH, an oxygen content in manure, an internal temperature, an internal humidity, an amount of methane, an amount of carbon dioxide, an amount of ammonia, a number of livestock, or a weight of livestock, or combination thereof.

In the collecting of the livestock house environment data, the processor may collect the livestock house environment data using a digital twin model.

In the generating of the plurality of carbon emission measurement models, the processor may generate one or more regression models using the livestock house environment data of each twin livestock house, and repeatedly verify and modify the generated regression model to generate one or more carbon emission measurement models.

In the generating of the plurality of carbon emission measurement models, the processor may analyze a correlation between the carbon emissions and each factor included in the livestock house environment data of each twin livestock house, select one or more factors on the basis of the analyzed correlation, and generate the one or more regression models using the selected factors.

In the generating of the plurality of carbon emission measurement models, the processor may select one or more factors that are easy to collect from the livestock house environment data, generate one or more deep learning models using the selected factors, and repeatedly train and update each generated deep learning model to generate one or more carbon emission measurement models.

In the generating of the plurality of carbon emission measurement models, the processor may select a factor object from a carbon cycle object model, generate one or more deep learning models using the selected factor object, and train and update each generated deep learning model using the livestock house environment data to generate one or more carbon emission measurement models.

The method may further include, after the generating of the plurality of carbon emission measurement models, when a user terminal requests a carbon emission measurement service, providing, by the processor, a list of the plurality of carbon emission measurement models to the user terminal, and measuring, by the processor, carbon emissions from a corresponding livestock house on the basis of a carbon emission measurement model selected by the user terminal.

In the measuring of the carbon emissions from the livestock house, the processor may generate an input value of the selected carbon emission measurement model in conjunction with the livestock house, and input the input value into the selected carbon emission measurement model to measure the carbon emissions from the livestock house.

In the measuring of the carbon emissions from the livestock house, the processor may receive an input value of the selected carbon emission measurement model from the user terminal, and input the input value into the selected carbon emission measurement model to measure the carbon emissions from the livestock house.

The twin livestock house may include a plurality of environmental facilities that form an environment of the livestock house, are operated, and provide information on operating results, a plurality of environmental sensors that detect environment information of the livestock house, and a controller that controls the operation of the plurality of environmental facilities, and transmits the livestock house environment data including at least one of control information used for operating the environmental facilities, the information on the operating results, or the environment information of the livestock house to a carbon emission measurement service server, or combination thereof.

According to another aspect of the present invention, there is provided a carbon emission measurement service server which includes a communication module configured to communicate with one or more twin livestock houses, and a processor connected to the communication module, wherein the processor collects livestock house environment data from the one or more twin livestock houses, and selects one or more factors from the collected livestock house environment data to generate a plurality of carbon emission measurement models.

The livestock house environment data may include external environment information including at least one of factors such as an external temperature, an external humidity, a wind speed, an atmospheric pressure, or a latitude, or combination thereof, and internal environment information including at least one of factors such as a manure temperature, a manure pH, an oxygen content in manure, an internal temperature, an internal humidity, an amount of methane, an amount of carbon dioxide, an amount of ammonia, a number of livestock, or a weight of livestock, or combination thereof.

The processor may generate one or more regression models using the livestock house environment data of each twin livestock house, and repeatedly verify and modify the generated regression model to generate one or more carbon emission measurement models.

The processor may analyze a correlation between the carbon emissions and each factor included in the livestock house environment data of each twin livestock house, select one or more factors on the basis of the analyzed correlation, and generate the one or more regression models using the selected factors.

The processor may select one or more factors that are easy to collect from the livestock house environment data, generate one or more deep learning models using the selected factors, and repeatedly train and update each generated deep learning model to generate one or more carbon emission measurement models.

The processor may select a factor object from a carbon cycle object model, generate one or more deep learning models using the selected factor object, and train and update each generated deep learning model using the livestock house environment data to generate one or more carbon emission measurement models.

When a user terminal requests a carbon emission measurement service, the processor may provide a list of the plurality of carbon emission measurement models to the user terminal, and measure carbon emissions from a corresponding livestock house on the basis of a carbon emission measurement model selected by the user terminal.

The processor may generate an input value of the selected carbon emission measurement model in conjunction with the livestock house, and input the input value into the selected carbon emission measurement model to measure the carbon emissions from the livestock house.

The processor may receive an input value of the selected carbon emission measurement model from the user terminal, and input the input value into the selected carbon emission measurement model to measure the carbon emissions from the livestock house.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram schematically illustrating a configuration of a carbon emission measurement service system according to an embodiment of the present invention;

FIG. 2 is a block diagram schematically illustrating a configuration of a carbon emission measurement service server according to an embodiment of the present invention;

FIG. 3 is an exemplary diagram for describing a method of generating a carbon emission measurement model according to an embodiment of the present invention;

FIG. 4 is a flowchart for describing a method of measuring carbon emissions according to an embodiment of the present invention;

FIG. 5 is a flowchart for describing a method of generating a carbon emission measurement model using a regression model according to an embodiment of the present invention; and

FIG. 6 is a flowchart for describing a method of generating a carbon emission measurement model using a deep learning model according to an embodiment of the present invention.

### DETAILED DESCRIPTION OF EXEMPLARY EMBODIMENTS

Hereinafter, examples of a method of measuring carbon emissions and a service server thereof according to the present invention will be described with reference to the accompanying drawings. In this process, thicknesses of lines, sizes of components, and the like illustrated in the drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

Expressions, such as “at least one of A, B or C or combination thereof,” when preceding a list of elements, modify the entire list of elements and do not modify the individual elements of the list. When phrases such as “at least one of A, B or C or combination thereof” are used to designate a list of elements A, B and C, the phrase may refer to any and all suitable combinations or a subset of A, B and C, such as A, B, C, A and B, A and C, B and C, or A and B and C.

In livestock houses, carbon is emitted from manure, the emission of the carbon affects environmental changes, and thus a method of compensating for this and calculating carbon emissions is required.

Accordingly, the present invention proposes a technology for calculating carbon emissions from livestock houses by generating a general-purpose carbon emission measurement model using a data model that accurately calculates carbon emissions from livestock houses. A data model may be generated in various forms. However, the accuracy of the model lies in the data itself rather than the structure of the data model. That is, the model may make accurate predictions only when the data is accurate, which means that a model that uses accurate data collected from a digital twin has a high probability of providing accurate predictions. This means that when the data is accurate, the accuracy of the predictions may be similar even when the data model is set in various ways. Therefore, the present invention relates to a technology for predicting carbon emissions by generating a model that uses a large number of factors and a model that uses a small number of factors based on accurate data.

The present invention relates to a method of generating a carbon emission measurement model using a data model generated from a digital twin-based livestock house (twin livestock house or test bed). In order to measure carbon emissions, equipment for measuring the carbon emissions should be installed, data should be obtained, and a carbon emission model should be generated. In addition, in order to calculate carbon emissions using a carbon emission model, the carbon emissions may be obtained only when input data required by the model is measured and input. Therefore, the carbon emission model is a valid technology only for farms that can obtain input data.

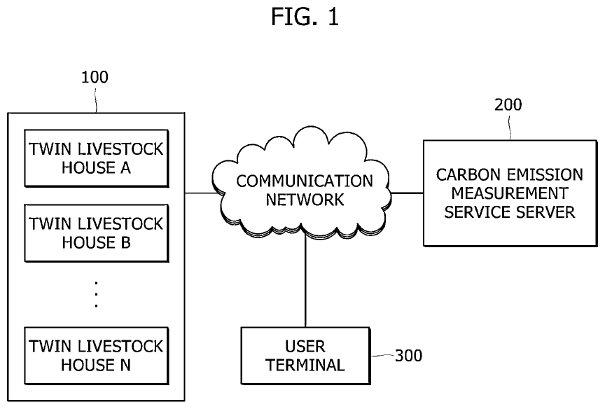

FIG. 1 is a block diagram schematically illustrating a configuration of a carbon emission measurement service system according to an embodiment of the present invention.

Referring to FIG. 1, the carbon emission measurement service system according to the embodiment of the present invention includes one or more twin livestock houses 100, a carbon emission measurement service server 200, and a user terminal 300.

The twin livestock house 100 may be a breeding facility for breeding pigs, poultry such as chickens, ducks, etc., or the like. The twin livestock house 100 may include a plurality of environmental facilities (not illustrated), a plurality of environmental sensors (not illustrated), and a controller (not illustrated).

The plurality of environmental facilities may be installed in the twin livestock house 100, may be operated according to control information of the controller, and may provide information on operating results to the controller. The environmental facilities according to an embodiment of the present invention may include a ventilation fan, a cooling pad, a water dispenser, a feed amount measuring device, a weight scale, and a feed bin residual amount measuring device.

The plurality of environmental sensors may collect environment information of the twin livestock house 100 and provide the collected environment information to the controller. The environmental sensors according to an embodiment of the present invention may include an internal thermometer, an internal hygrometer, a carbon dioxide meter, an ammonia meter, an external thermometer, an external hygrometer, an irradiance meter, a precipitation meter, an anemometer, a wind vane, etc.

The controller may control the plurality of environmental facilities using the control information.

Further, the controller may collect the control information used for operating the environmental facilities, the environment information of the livestock house, and the information on the operating results, on the basis of time, and transmit the collected control information to the carbon emission measurement service server 200.

The controller may collect livestock house environment data and transmit the collected livestock house environment data to the carbon emission measurement service server 200. Here, the livestock house environment data may include internal environment information and external environment information. The internal environment information may include a manure temperature, a manure pH, an oxygen content in manure, an internal temperature, an internal humidity, an amount of methane, an amount of carbon dioxide, an amount of ammonia, the number of livestock, the weight of livestock, etc. The external environment information may include an external temperature, an external humidity, a wind speed, an atmospheric pressure, a latitude, etc.

The environmental facilities, the environmental sensors, and the controller may be implemented with Internet of things (IoT) communication modules, but the present invention is not limited thereto, and the environmental facilities, the environmental sensors, and the controller may be implemented with various wired communication modules and wireless communication modules. Among the communication modules, the wired communication module may be implemented with a power line communication device, a telephone line communication device, a cable home (MoCA), Ethernet, Institute of Electrical and Electronics Engineers (IEEE) 1294, an integrated wired home network, and a Recommended Standard 485 (RS-485) control device, and the wireless communication modules may be implemented with a wireless local area network (WLAN), Bluetooth, a high data rate wireless personal area network (HDR-WPAN), ultra-wideband (UWB), Zigbee, impulse radio, a 60 GHz WPAN, binary code-division multiple access (CDMA), wireless Universal Serial Bus (USB) technology, wireless High-Definition Multimedia Interface (HDMI) technology, fifth generation (5G) mobile communication technology, etc.

The carbon emission measurement service server 200 may collect the livestock house environment data from the one or more twin livestock houses 100, select one or more factors from the collected livestock house environment data, and generate a plurality of carbon emission measurement models.

Further, when the user terminal 300 requests a carbon emission measurement service, the carbon emission measurement service server 200 may provide a list of the plurality of carbon emission measurement models to the user terminal 300, and measure carbon emissions of a corresponding livestock house on the basis of the carbon emission measurement model selected by the user terminal 300 to provide the measured carbon emissions of the corresponding livestock house to the user terminal 300.

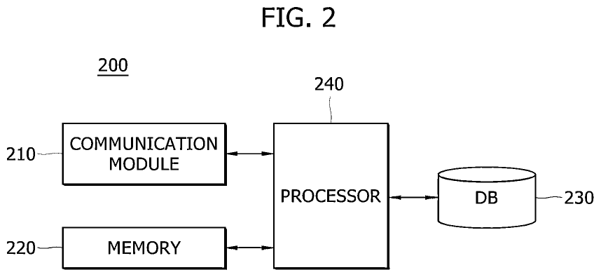

A detailed description of the carbon emission measurement service server 200 will be given with reference to FIG. 2.

The user terminal 300 may execute and/or display a carbon emission measurement service program (application) or a carbon emission measurement service site provided by the carbon emission measurement service server 200, and the carbon emission measurement service server 200 that receives the user's access identification information (ID) and password through the user terminal 300 may perform user authentication on the carbon emission measurement service program (application) or carbon emission measurement service site.

The user terminal 300 may use the carbon emission measurement service by accessing the carbon emission measurement service server 200.

The user terminal 300 may include a desktop computer, a smartphone, a notebook computer, a tablet computer, a smart television (TV), a mobile phone, a personal digital assistant (PDA), a laptop computer, a media player, a micro server, a Global Positioning System (GPS) device, an e-book reader, a digital broadcasting terminal, a navigation device, a kiosk, a Moving Picture Experts Group (MPEG) audio layer-3 (MP3) player, a digital camera, a home appliance, or another mobile or non-mobile computing device operated by a user, but the present invention is not limited thereto. Further, the user terminal 300 may be a wearable terminal such as a watch, glasses, a hair band, or a ring equipped with a communication function and a data processing function. The user terminal 300 is not limited to the above-described content, and a terminal capable of web browsing may be used without limitation.

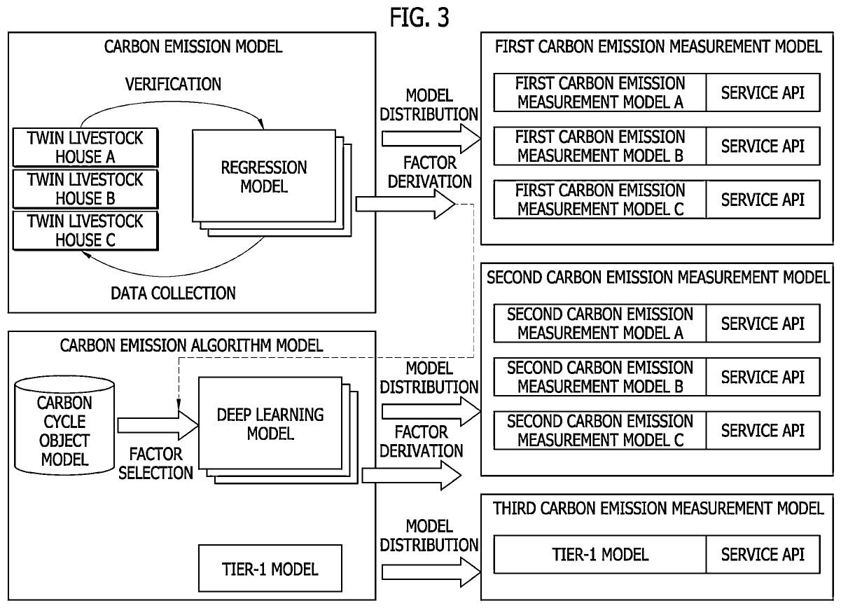

FIG. 2 is a block diagram schematically illustrating a configuration of a carbon emission measurement service server according to an embodiment of the present invention, and FIG. 3 is an exemplary diagram for describing a method of generating a carbon emission measurement model according to an embodiment of the present invention.

Referring to FIG. 2, the carbon emission measurement service server 200 according to the embodiment of the present invention includes a communication module 210, a memory 220, a database 230, and a processor 240.

The communication module 210 may provide a communication interface that is required to provide transmission and reception signals in the form of packet data between the carbon emission measurement service server 200 and the twin livestock house 100 or between the carbon emission measurement service server 200 and the user terminal 300 by linking with a communication network. Furthermore, the communication module 210 may receive livestock house environment data from the twin livestock house 100. Further, the communication module 210 may receive a carbon emission measurement service request from the user terminal 300 and provide a carbon emission measurement service. Further, the communication module 210 may be a device including hardware and software that are required for transmitting and receiving signals such as control signals or data signals through wired and wireless connections with other network devices. Further, the communication module 210 may be implemented in various forms such as a short-range communication module, a wireless communication module, a mobile communication module, a wired communication module, etc.

The memory 220 is a component for storing data related to the operation of the carbon emission measurement service server 200. In particular, in the memory 220, a program (application or applet) and the like that enable the generation of a plurality of carbon emission measurement models may be stored, and the stored information may be selected by the processor 240 as necessary. Further, in the memory 220, a program (application or applet) and the like that can provide a carbon emission measurement service using a carbon emission measurement model may be stored. Further, in the memory 220, a plurality of carbon emission measurement models generated by the processor 240 may be stored. Further, in the memory 220, various types of data generated during the execution of an operating system or a program (application or applet) for operating the carbon emission measurement service server 200 are stored. In this case, “memory” 220 is a general term for a non-volatile storage device that maintains stored information even when power is not supplied and a volatile storage device that requires power to maintain stored information. Further, the memory 220 may perform a function of temporarily or permanently storing data processed by the processor 240. Here, the memory 220 may include a magnetic storage medium or a flash storage medium in addition to the volatile storage device that requires power to maintain stored information, but the scope of the present invention is not limited thereto.

The database 230 may store livestock house environment data for each twin livestock house 100, carbon emission measurement information for each livestock house, etc.

Meanwhile, in the embodiment of the present invention, although the database 230 is described as being included in the carbon emission measurement service server 200, the database 230 may be provided in an external device connected to the carbon emission measurement service server 200 via a wired or wireless communication network.

The processor 240 may be configured to control the overall operation of the carbon emission measurement service server 200. For example, the processor 240 may execute software (e.g., a program) stored in the memory 220 to control the components connected to the processor 240 (e.g., at least one of the communication module 210, the memory 220, or the database 230). The processor 240 may be implemented with an application-specific integrated circuit (ASIC), a digital signal processor (DSP), a programmable logic device (PLD), a field programmable gate array (FPGA), a central processing unit (CPU), a microcontroller, and/or a microprocessor, but the present invention is not limited thereto.

The processor 240 may collect livestock house environment data from one or more twin livestock houses 100, select one or more factors from the collected livestock house environment data, and generate a plurality of carbon emission measurement models.

Hereinafter, the operation of the processor 240 will be described in detail.

In order to generate the carbon emission measurement model, a digital twin model is required. The digital twin model may be defined as a model at a level of collecting and managing the livestock house environment data in connection with the twin livestock house 100 (test bed livestock house).

The processor 240 may collect livestock house environment data from one or more twin livestock houses 100. Here, the livestock house environment data may include internal environment information and external environment information. The internal environment information may include factors such as a manure temperature, a manure pH, an oxygen content in manure, an internal temperature, an internal humidity, an amount of methane, an amount of carbon dioxide, an amount of ammonia, the number of livestock, the weight of livestock, etc. The external environment information may include factors such as an external temperature, an external humidity, a wind speed, an atmospheric pressure, a latitude, etc.

The processor 240 may collect and manage the livestock house environment data using a digital twin model.

When the livestock house environment data is collected, the processor 240 may select one or more factors from the livestock house environment data and generate a plurality of carbon emission measurement models. In this case, the processor 240 may generate the carbon emission measurement models using a regression model, a deep learning model, or the like.

First, a method in which the processor 240 generates a carbon emission measurement model using a regression model will be described.

The processor 240 may generate one or more regression models using the livestock house environment data of each twin livestock house 100 and repeatedly verify and modify each regression model to generate one or more carbon emission measurement models.

The processor 240 may analyze a correlation between carbon emissions and each factor included in the livestock house environment data of each twin livestock house 100, select one or more factors on the basis of the analyzed correlation, and generate one or more regression models using the selected factors.

The processor 240 may generate multiple regression models with multiple independent variables. Methane may be a dependent variable of the regression model, and other factors may be independent variables. That is, methane may be an output factor of the regression model, and other factors may be input factors.

A regression model may be a linear equation, the linear equation may be a numerical model, and the numerical model may have accurate predicted values (dependent variables) when data values are accurate. Therefore, the processor 240 may select a factor that has a high correlation with carbon emissions, a factor that is easy to measure, etc., from among the factors included in the livestock house environment data, and may generate one or more regression models using the selected factors.

When the one or more regression models are generated, the processor 240 may repeatedly verify and modify each regression model using the livestock house environment data of each twin livestock house 100 to generate one or more carbon emission measurement models.

Next, a method in which the processor 240 generates a carbon emission measurement model using a deep learning model will be described.

The processor 240 may select one or more factors that are easy to collect from the livestock house environment data, generate one or more deep learning models using the selected factors, and repeatedly train and update the generated deep learning model to generate one or more carbon emission measurement models.

The processor 240 may generate a deep learning model using livestock house environment data collected through a digital twin model. In this case, the processor 240 may select some factors included in the livestock house environment data or generate a time series deep learning model using all the factors. The deep learning model is a data-based model, and may be generated by selecting factors centered on the ease of data that can be collected from the twin livestock house 100 and using the selected factors.

The processor 240 may continuously collect livestock house environment data collected from one or more twin livestock houses 100 (digital twin models) after being connected to the one or more twin livestock houses 100 (digital twin models) to generate a data set.

The processor 240 may repeatedly train and update the deep learning model to generate one or more carbon emission measurement models using the livestock house environment data.

The deep learning model is a model trained using an accurate data set of a digital twin, and as the twin livestock house 100 (test bed livestock house) is added and the data set is increased, the deep learning model has higher accuracy. That is, the larger and more accurate the data set, the higher the prediction probability of the carbon emission measurement model, and thus when there is a sufficient and accurate data set, a deep learning model with a similar prediction probability may be obtained even when a deep learning model is generated using some factors.

Further, the processor 240 may select a factor object from the carbon cycle object model, generate one or more deep learning models using the selected factor object, and train and update each deep learning model using the livestock house environment data to generate one or more carbon emission measurement models.

The carbon cycle object model may be a model that objectifies factors provided by a digital twin from which the factors that can be used in a carbon emission algorithm are collected. Therefore, the processor 240 may perform a procedure for selecting the factor object from the carbon cycle object model, setting the factor object as an object used by the deep learning model, generating a deep learning model, and then training the deep learning model using the data collected from the twin livestock house 100 (digital twin model). In this case, the processor 240 may select the factor object, generate a plurality of deep learning models in various combinations, train the plurality of deep learning models, and then generate the carbon emission measurement model.

As described above, the processor 240 may generate the model on the basis of a sufficient and accurate data set, verify the prediction probability, and then change the factors of the model to generate a new model. Generally, it is true that it is difficult to collect breeding information of livestock farms other than the number of breeding pigs and farm address information. The carbon emission measurement model may be generated targeting the total weight of pigs and external environmental factors among the data set factors.

For example, a method of generating a carbon emission measurement model will be described with reference to FIG. 3.

The processor 240 may generate one or more first carbon emission measurement models on the basis of regression models derived from each of a twin livestock house A, a twin livestock house B, and a twin livestock house C. The first carbon emission measurement models are twin models generated based on the regression models derived for each twin livestock house 100, and may be the most accurate models because the first carbon emission measurement models may calculate predicted values based on actual measurement data of each farm.

The processor 240 may analyze a correlation between carbon emissions and each factor included in the livestock house environment data of each of the twin livestock house A, the twin livestock house B, and the twin livestock house C, select one or more factors on the basis of the analyzed correlation, and generate a regression model A, a regression model B, and a regression model C using the selected factors. Thereafter, the processor 240 may verify and modify each of the regression model A, the regression model B, and the regression model C to generate a first carbon emission measurement model A, a first carbon emission measurement model B, and a first carbon emission measurement model C.

Further, the processor 240 may select some factors from the livestock house environment data collected from the twin livestock house A, the twin livestock house B, and the twin livestock house C, distinguish the factors into levels, and generate deep learning models using the factors distinguished into the levels. For example, the processor 240 may generate a deep learning model A using external environment information and a total weight of livestock as factors of level 1. The processor 240 may generate a deep learning model B using external environment information, the total weight of livestock, an amount of carbon dioxide, and an amount of ammonia as factors of level 2. The processor 240 may generate a deep learning model C using external environment information and internal environment information as factors of level 3.

The processor 240 may train and update each of the deep learning model A, the deep learning model B, and the deep learning model C using the livestock house environment data to generate a second carbon emission measurement model A, a second carbon emission measurement model B, and a second carbon emission measurement model C.

The processor 240 may distribute one or more first carbon emission measurement models and one or more second carbon emission measurement models and provide a service application program interface (API) to provide a carbon emission measurement service to a user.

The processor 240 may provide a Tier-1 model that calculates carbon emissions using a default emission coefficient value defined by the Intergovernmental Panel on Climate Change (IPCC) as a third carbon emission measurement model. The third carbon emission measurement model is a model that calculates carbon emissions using the default emission coefficient value, and may be generated with a structure that uses the number of livestock. The processor 240 may distribute the third carbon emission measurement model and provide a service API to provide the carbon emission measurement service to the user.

As described above, the processor 240 may accurately measure the carbon emissions using the digital twin and objectify the factors affecting the carbon emissions to structure the deep learning model for measuring the carbon emissions in various ways. Further, the processor 240 may generate a regression model (regression equation) as a factor affecting carbon emissions using a digital twin to generate a carbon emission measurement model that can be applied to a twin livestock house (farm). Further, the processor 240 may generate a Tier-1 model that measures carbon emissions using the emission coefficient provided by the IPCC. In this way, the processor 240 may provide the carbon emission measurement service using a carbon emission measurement model that can be generally used and a carbon emission measurement model that can be used for twin livestock houses (farms).

When one or more carbon emission measurement models are generated, the processor 240 may distribute the carbon emission measurement models and provide a service API to provide the carbon emission measurement service to the user.

When the user terminal 300 requests the carbon emission measurement service, the processor 240 may provide a list of a plurality of carbon emission measurement models to the user terminal 300, measure carbon emissions of a corresponding livestock house on the basis of the carbon emission measurement model selected by the user terminal 300, and provide the measured carbon emissions to the user terminal 300.

Specifically, when the user terminal 300 accesses the carbon emission measurement service server 200 and requests the carbon emission measurement service, the processor 240 may provide the list of the carbon emission measurement models to user terminal 300.

The user terminal 300 may select a carbon emission measurement model suitable for its livestock house from the list of the carbon emission measurement models. Then, the processor 240 may generate an input value of the corresponding carbon emission measurement model in conjunction with the livestock house or receive the input value of the corresponding carbon emission measurement model from the user terminal 300 to generate input data required for the corresponding carbon emission measurement model.

Thereafter, the processor 240 may input the input value generated in conjunction with the livestock house or the input value input by the user terminal 300 into the carbon emission measurement model selected by the user to measure the carbon emissions from the livestock house.

Since the livestock house environment data is managed in the database 230 by distinguishing the twin livestock house 100 from the livestock house without digital twin linkage (general livestock house), the processor 240 may generate the input data using the livestock house environment data managed in the database 230. The carbon emissions may be measured in conjunction with the livestock house information or measured through a user's direct input, and results of the measurement may be stored and managed in the database 230. The livestock house-linked measurement involves generating an input value of the corresponding carbon emission measurement model in conjunction with the livestock house information and then measuring the carbon emission, and the user input measurement involves generating an input value of the corresponding carbon emission measurement model directly by a user and then measure the carbon emission.

For example, a case in which the first carbon emission measurement model A illustrated in FIG. 3 is used will be described. The livestock house-linked measurement may be implemented by retrieving the number of livestock in the twin livestock house A from the database 230 and using the number of livestock in the twin livestock house A as input to the first carbon emission measurement model A, and the user input measurement may be implemented by using the number of livestock as input by the user specifying the number of livestock as 100.

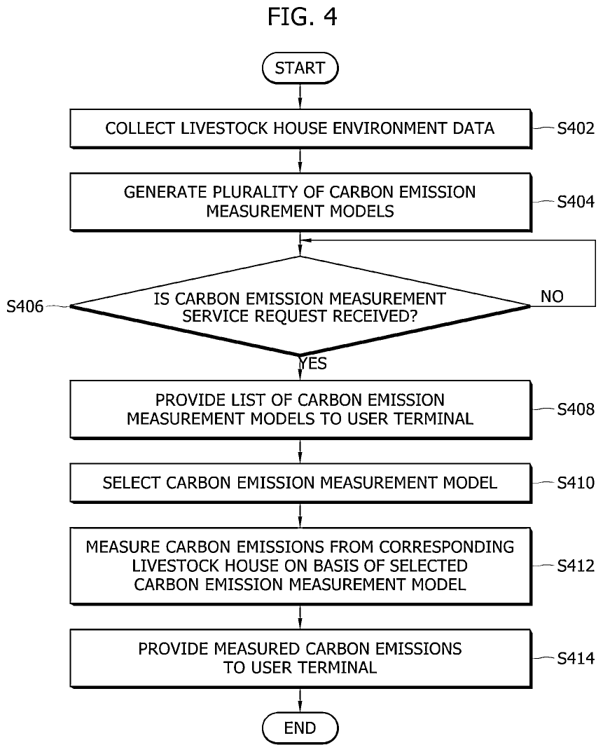

FIG. 4 is a flowchart for describing a method of measuring carbon emissions according to an embodiment of the present invention.

Referring to FIG. 4, a processor 240 collects livestock house environment data from one or more twin livestock houses 100 (S402). In this case, the processor 240 may collect the livestock house environment data using a digital twin model.

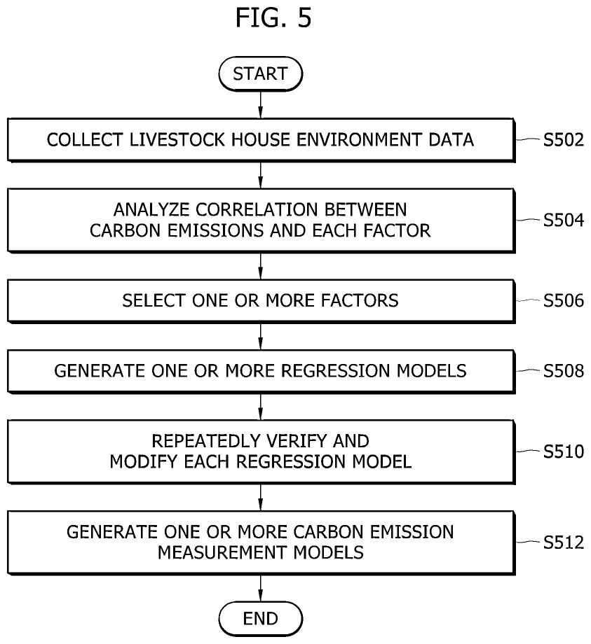

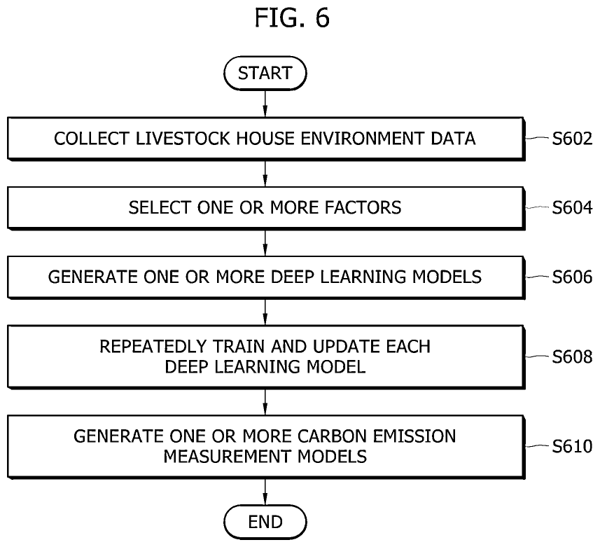

When operation S402 is performed, the processor 240 selects one or more factors from the livestock house environment data and generates a plurality of carbon emission measurement models (S404). In this case, the processor 240 may generate the carbon emission measurement models using a regression model, a deep learning model, or the like. A detailed description of a method of generating a carbon emission measurement model using a regression model will be given with reference to FIG. 5, and a detailed description of a method of generating a carbon emission measurement model using a deep learning model will be given with reference to FIG. 6.

After operation S404 is performed, when a user terminal 300 requests a carbon emission measurement service (S406), the processor 240 provides a list of the carbon emission measurement models to the user terminal 300 (S408). When the user terminal 300 accesses a carbon emission measurement service server 200 and requests the carbon emission measurement service, the processor 240 may provide the list of the carbon emission measurement models to the user terminal 300.

After operation S408 is performed, when a carbon emission measurement model is selected by the user terminal 300 (S410), the processor 240 measures carbon emissions of a corresponding livestock house on the basis of the carbon emission measurement model selected by the user terminal 300 (S412).

The user terminal 300 may select a carbon emission measurement model suitable for its livestock house from the list of the carbon emission measurement models. Then, the processor 240 may generate an input value of the corresponding carbon emission measurement model in conjunction with the livestock house or receive the input value of the corresponding carbon emission measurement model from the user terminal 300 to generate input data required for the corresponding carbon emission measurement model. Thereafter, the processor 240 may input the input value generated in conjunction with the livestock house or the input value input by the user terminal 300 into the selected carbon emission measurement model to measure the carbon emissions from the livestock house.

When operation S412 is performed, the processor 240 provides the measured carbon emissions to the user terminal 300 (S414). In this case, the processor 240 may match the measured carbon emissions to the corresponding livestock house and store a result of the matching in the database 230.

FIG. 5 is a flowchart for describing a method of generating a carbon emission measurement model using a regression model according to an embodiment of the present invention.

Referring to FIG. 5, the processor 240 collects livestock house environment data from the one or more twin livestock houses 100 (S502). In this case, the processor 240 may collect the livestock house environment data using a digital twin model.

When operation S502 is performed, the processor 240 analyzes a correlation between carbon emissions and each of factors included in the livestock house environment data of each twin livestock house 100 (S504), and selects one or more factors on the basis of the analyzed correlation (S506). In this case, the processor 240 may select the one or more factors in order of highest correlation.

When operation S506 is performed, the processor 240 generates one or more regression models using the selected factors (S508). In this case, the processor 240 may generate multiple regression models with multiple independent variables.

When operation S508 is performed, the processor 240 repeatedly verifies and modifies each regression model using the livestock house environment data of each twin livestock house 100 (S510) to generate one or more carbon emission measurement models (S512).

FIG. 6 is a flowchart for describing a method of generating a carbon emission measurement model using a deep learning model according to an embodiment of the present invention.

Referring to FIG. 6, the processor 240 collects livestock house environment data from the one or more twin livestock houses 100 (S602). In this case, the processor 240 may collect the livestock house environment data using a digital twin model.

When operation S602 is performed, the processor 240 selects one or more factors that are easy to collect from the livestock house environment data or selects one or more factors from a carbon cycle object model (S604).

When operation S604 is performed, the processor 240 generates one or more deep learning models using the selected factors (S606).

When operation S606 is performed, the processor 240 repeatedly trains and updates each deep learning model using the livestock house environment data (S608) to generate one or more carbon emission measurement models (S610).

The method of measuring the carbon emissions and the service server thereof according to some embodiments of the present invention can enable the measurement of carbon emissions from livestock houses by generating a carbon emission measurement model that can be generally used using a data model that accurately calculates the carbon emissions from the livestock house, and thus can measure carbon emissions more accurately than a method in which emission coefficients provided by the IPCC is used, by using the number of livestock (or total weight), which is data that can generally be obtained from livestock houses (farms), and external environmental data that can be obtained from the Korea Meteorological Administration, without data obtained from specialized measuring equipment required for carbon measurement.

The method of measuring the carbon emissions and the service server thereof according to some embodiment of the present invention can enable the measurement of carbon emissions from livestock houses by generating a carbon emission measurement model that can be generally used using a data model that accurately calculates the carbon emissions from the livestock house, and thus can measure carbon emissions more accurately than a method in which emission coefficients provided by the IPCC is used, by using the number of livestock (or total weight), which is data that can generally be obtained from livestock houses (farms), and external environmental data that can be obtained from the Korea Meteorological Administration, without data obtained from specialized measuring equipment required for carbon measurement.

Meanwhile, the term “unit” used herein may include a unit composed of hardware, software, or firmware, and for example, may be used interchangeably with a term such as “logic,” “logic block,” “component,” or “circuit.” A unit may be an integrally constituted part or a minimum unit or a part thereof that performs one or more functions. For example, a unit may be configured as an ASIC.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. A method of measuring carbon emissions, comprising:
collecting, by a processor, livestock house environment data from one or more twin livestock houses; and
selecting, by the processor, one or more factors from the livestock house environment data and generating a plurality of carbon emission measurement models.

2. The method of claim 1, wherein the livestock house environment data includes external environment information including at least one of factors such as an external temperature, an external humidity, a wind speed, an atmospheric pressure, or a latitude, or combination thereof, and internal environment information including at least one of factors such as a manure temperature, a manure pH, an oxygen content in manure, an internal temperature, an internal humidity, an amount of methane, an amount of carbon dioxide, an amount of ammonia, a number of livestock, or a weight of livestock, or combination thereof.

3. The method of claim 1, wherein, in the collecting of the livestock house environment data, the processor collects the livestock house environment data using a digital twin model.

4. The method of claim 1, wherein, in the generating of the plurality of carbon emission measurement models, the processor generates one or more regression models using the livestock house environment data of each twin livestock house, and repeatedly verifies and modifies the generated regression model to generate one or more carbon emission measurement models.

5. The method of claim 4, wherein, in the generating of the plurality of carbon emission measurement models, the processor analyzes a correlation between the carbon emissions and each factor included in the livestock house environment data of each twin livestock house, selects one or more factors on the basis of the analyzed correlation, and generates the one or more regression models using the selected factors.

6. The method of claim 1, wherein, in the generating of the plurality of carbon emission measurement models, the processor selects one or more factors that are easy to collect from the livestock house environment data, generates one or more deep learning models using the selected factors, and repeatedly trains and updates each generated deep learning model to generate one or more carbon emission measurement models.

7. The method of claim 1, wherein, in the generating of the plurality of carbon emission measurement models, the processor selects a factor object from a carbon cycle object model, generates one or more deep learning models using the selected factor object, and trains and updates each generated deep learning model using the livestock house environment data to generate one or more carbon emission measurement models.

8. The method of claim 1, further comprising, after the generating of the plurality of carbon emission measurement models:
when a user terminal requests a carbon emission measurement service, providing, by the processor, a list of the plurality of carbon emission measurement models to the user terminal; and
measuring, by the processor, carbon emissions from a corresponding livestock house on the basis of a carbon emission measurement model selected by the user terminal.

9. The method of claim 8, wherein, in the measuring of the carbon emissions from the livestock house, the processor generates an input value of the selected carbon emission measurement model in conjunction with the livestock house, and inputs the input value into the selected carbon emission measurement model to measure the carbon emissions from the livestock house.

10. The method of claim 8, wherein, in the measuring of the carbon emissions from the livestock house, the processor receives an input value of the selected carbon emission measurement model from the user terminal, and inputs the input value into the selected carbon emission measurement model to measure the carbon emissions from the livestock house.

11. The method of claim 1, wherein the twin livestock house includes:
a plurality of environmental facilities that form an environment of the livestock house, are operated, and provide information on operating results;
a plurality of environmental sensors that detect environment information of the livestock house; and
a controller that controls the operation of the plurality of environmental facilities, and transmits the livestock house environment data including at least one of control information used for operating the environmental facilities, the information on the operating results, or he environment information of the livestock house to a carbon emission measurement service server, or combination thereof.

12. A carbon emission measurement service server comprising:
a communication module configured to communicate with one or more twin livestock houses; and
a processor connected to the communication module,
wherein the processor collects livestock house environment data from the one or more twin livestock houses, and selects one or more factors from the collected livestock house environment data to generate a plurality of carbon emission measurement models.

13. The carbon emission measurement service server of claim 12, wherein the livestock house environment data includes external environment information including at least one of factors such as an external temperature, an external humidity, a wind speed, an atmospheric pressure, or a latitude, or combination thereof, and internal environment information including at least one of factors such as a manure temperature, a manure pH, an oxygen content in manure, an internal temperature, an internal humidity, an amount of methane, an amount of carbon dioxide, an amount of ammonia, a number of livestock, or weight of livestock, or combination thereof.

14. The carbon emission measurement service server of claim 12, wherein the processor generates one or more regression models using the livestock house environment data of each twin livestock house, and repeatedly verifies and modifies the generated regression model to generate one or more carbon emission measurement models.

15. The carbon emission measurement service server of claim 14, wherein the processor analyzes a correlation between the carbon emissions and each factor included in the livestock house environment data of each twin livestock house, selects one or more factors on the basis of the analyzed correlation, and generates the one or more regression models using the selected factors.

16. The carbon emission measurement service server of claim 12, wherein the processor selects one or more factors that are easy to collect from the livestock house environment data, generates one or more deep learning models using the selected factors, and repeatedly trains and updates each generated deep learning model to generate one or more carbon emission measurement models.

17. The carbon emission measurement service server of claim 12, wherein the processor selects a factor object from a carbon cycle object model, generates one or more deep learning models using the selected factor object, and trains and updates each generated deep learning model using the livestock house environment data to generate one or more carbon emission measurement models.

18. The carbon emission measurement service server of claim 12, wherein, when a user terminal requests a carbon emission measurement service, the processor provides a list of the plurality of carbon emission measurement models to the user terminal, and measures carbon emissions from a corresponding livestock house on the basis of a carbon emission measurement model selected by the user terminal.

19. The carbon emission measurement service server of claim 18, wherein the processor generates an input value of the selected carbon emission measurement model in conjunction with the livestock house, and inputs the input value into the selected carbon emission measurement model to measure the carbon emissions from the livestock house.

20. The carbon emission measurement service server of claim 18, wherein the processor receives an input value of the selected carbon emission measurement model from the user terminal, and inputs the input value into the selected carbon emission measurement model to measure the carbon emissions from the livestock house.
